(19) United States
(12) Patent Application Publication
(10) Pub. No.: US 2008/0162311 A1
(43) Pub. Date: Jul. 3, 2008

(54) Process and system for web-based evaluated receipt settlement of invoices

(75) Inventors: Thomas Rowe Hendrix, Louisville, KY (US); Scott Dvorak, Louisville, KY (US); Patricia Slone Peet, Louisville, KY (US); Harry Arnold James, Louisville, KY (US); Martin Jacob Ritter, Louisville, KY (US); Wendy D'Angelo, Plainville, CT (US); Lisa Wheatley Whitmire, Louisville, KY (US); Eric Osiecki, Louisville, KY (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: GENERAL ELECTRIC COMPANY

(21) Appl. No.: 11/646,209

(22) Filed: Dec. 27, 2006

(51) Int. Cl. G06Q 30/00

(52) U.S. Cl. 705/34

(57) ABSTRACT

A method for web-based evaluated receipt settlement of a invoice, the method comprising: generating a purchase order number for a product; shipping of the product to customer by supplier; issuing of a receipt settlement via an Internet or Intranet to the customer; determining if a shipping notice exists to receive against the receipt settlement; generating a receiver file if a shipping notice exists; determining if there is any discrepancy between the shipping notice and the quantity of the products set forth in the receiver file; determining if the receiver file should be released to accounts payable; and performing a 2-way match of the receiver file.

### BACKGROUND

1. Field

The present disclosure generally relates to an automated shipping notice/invoicing system that allows a supplier to make late adjustments to a purchase order (PO) (e.g., exchange rates, actual shipping details, etc.) and for the customer to create an electronic ASN based on the updated information provided by the supplier.

2. Discussion of the Background Art

For international suppliers, customers were required to key all international invoices via a paper invoice system. This was done in order to meet the Customs' requirements. Some businesses offer a web invoicing application which brings an invoice into the accounts payable system immediately. Paper invoices add processing costs and the potential for input/keypunch errors. Creating invoices, whether paper or web-invoicing solutions, could also create unmatched invoice queues (situations where an invoice has been input into the system, but the product has not yet been received). Both paper and web invoicing solutions still rely on a 3-way matching concept within a payables processing system.

The present disclosure creates another type of PO record, i.e., it allows businesses to capture price adjustments where the PO has not been updated and the supplier charges a lower price than the purchase order. It also allows for underpayment avoidance—such underpayments to be caught upfront by pushing the record (once in account payable) to the buyers queue for resolution before making the payment. The present disclosure avoids the problems associated with Customs' requirements for international suppliers which are paid in United States dollars. That is, the process of the present disclosure allows international suppliers to be paid via a PO record which was not acceptable in the past due to Customs' requirements that supplier provided price. This is a much more automated solution than receiving paper invoices from suppliers or file fed invoice details which require a 3-way match in accounts payable. The present disclosure enables automation (i.e., 2-way match), which did not previously exit. That is, using a 2-way match according to the present disclosure provides that invoices will be input into the system after product has been received.

The present disclosure has the following advantages over conventional invoicing systems: (1) reduction of accounts payable queues, (2) automation, (3) lower cost per document, (4) up-front communication with the supplier on issues and (5) the matching of the price paid to the price declared to US Customs. Additionally, the present disclosure has the following key features: 2-way match in accounts payable, price being captured, price checks against the PO, payment reference provided by the supplier, and is an ASN record versus an invoice.

The present disclosure also provides many additional advantages, which shall become apparent as described below.

### SUMMARY

A method for web-based evaluated receipt settlement of a invoice, the method comprising: generating a purchase order number for a product; shipping of the product to customer by supplier; issuing of a receipt settlement via an Internet or Intranet to the customer; determining if a shipping notice exists to receive against the receipt settlement; generating a receiver file if a shipping notice exists; determining if there is any discrepancy between the shipping notice and the quantity of the products set forth in the receiver file; determining if the receiver file should be released to accounts payable; and performing a 2-way match of the receiver file.

The 2-way match comprises:
comparing the ASN on the receipt with the ASN recorded by the supplier. If the quantity, supplier and ASN match, then the ASN is considered closed and the receipt is then sent to AP.
If the quantity does not match, then a notice is sent to the supplier indicating that the quantities are different and that they must verify the received quantity.
   The supplier can use Web-ERS to confirm the change in quantity. If the supplier does not agree with the received quantity, they will contact plant/buyer to resolve quantity differences.

The method further comprises: if there is no shipping notice to receive against, manually inserting receipt data; and generating the receiver file.

The method further comprising: if there is a discrepancy between the shipping notice and the quantity of the products set forth in the receiver file, transmitting a confirmation request to the supplier; determining if the supplier confirms the quantity and an input price; and if the supplier confirms the quantity and the input price, releasing the receiver file to accounts payable.

Preferably, the step of generating a purchase order number for a product comprises: logging onto a website by the supplier; selecting a web-based evaluated receipt settlement link; entering a desired customer; and entering a purchase order.

The present disclosure also includes a method for generating an automated shipping notice for a product to be shipped, the method comprising: logging on to an automated shipping notice website; selecting an available purchase order for the product; inputting automated shipping notice data; submitting the automated shipping notice data; and confirming that the automated shipping notice has been logged into memory.

Further objects, features and advantages of the present disclosure will be understood by reference to the following drawings and detailed description.

### BRIEF DESCRIPTION OF THE DRAWINGS

FIG. 1 is a block diagram of the process flow of the web invoicing according to the present disclosure;

FIG. 2 is a block diagram of the supplier entry process according to the present disclosure;

FIG. 3 is a block diagram of E-pack and purchasing acknowledgement of web invoicing supplier;

FIG. 4 is a logic flow diagram of the pay on receiver process according to the present disclosure; and

FIGS. 5-13 are screen shots of the process according to the present disclosure.

### DETAILED DESCRIPTION OF THE PREFERRED EMBODIMENT

The present disclosure produces an automated shipping notice (ASN) with supplier input pricing. The supplier will be creating an ASN record online by first searching for a purchase order (PO) number. Once the PO is found in the system, the supplier will input specific fields (e.g., Web ERS (Evaluated Receipt Settlement) number/payment reference number, shipment identification number, quantity, unit price, and extended amount). This ASN record will be sent to Oracle or other database receiving and can then be received against by a plant location. This receiver/ASN record will be sent back to E-pack (i.e., E-pack is an application that is use to record receipt against an ASN and is the interface application to Accounts Payable) and then on to accounts payable, which will treat the record as a Pay On Receipt record and will create an invoice from this receipt. Once the record is passed to accounts payable it becomes an invoice. This process has a prematched ASN and PO prior to accounts payable.

There are a few items which are key in the process of the present disclosure in order to keep this as an ERS (Evaluated Receipt Settlement) type application. First, the ASN input by the supplier does not become an invoice until it is received against by the business (i.e., customer) and passed to the accounts payable system. If not received by the business, then the ASN record will be dropped and will not become an invoice. For manual receipts, the supplier will be required to verify the information entered by the business (e.g., quantity, etc.) and input a payment reference number. This will assist the supplier in the cash application process and reduce the time accounts payable spends in researching payments for vendors. Price input is also key in this process since in the traditional 2-way match process price is not captured, but rather pulled from the PO price.

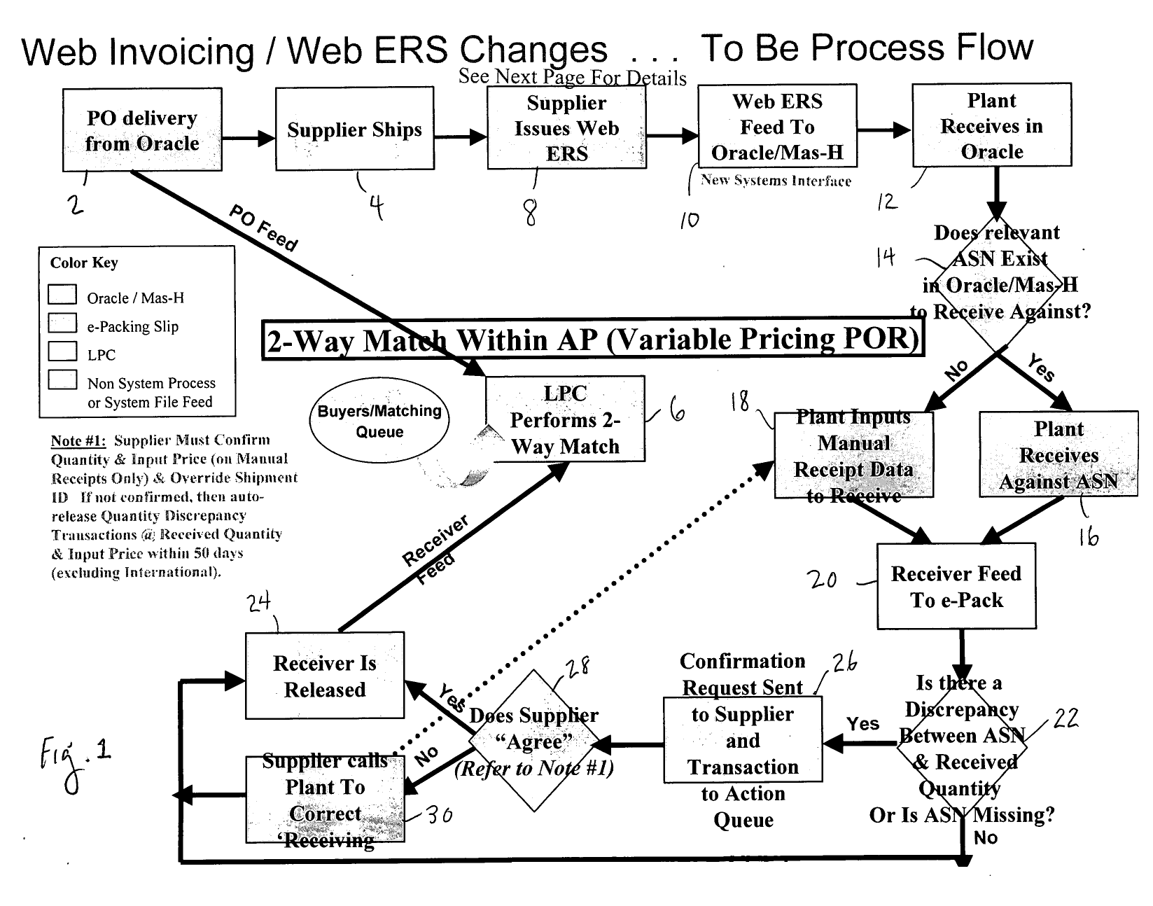

The present disclosure can best be described by referring to the drawings, attached hereto, wherein FIG. 1 is a block diagram depicting the web invoicing/web ERS process flow. Initially, a PO is delivered from Oracle 2 to both the supplier 4 which then ships the product and simultaneously to LPC 6 (Louisville Payment Center) which performs a 2-way match (1) Comparing the ASN on the receipt with the ASN recorded by the supplier. If the quantity, supplier and ASN match, then the ASN is considered closed and the receipt is then sent to AP. (2) If the quantity does not match, then a notice is sent to the supplier indicating that the quantities are different and that they must verify the received quantity. The supplier can use Web-ERS to confirm the change in quantity. If the supplier does not agree with the received quantity, they will contact Buyer to resolve quantity differences. Thereafter, the supplier issues a web ERS 8, the web ERS 8 is then fed to Oracle/Mas-H 10 (purchasing/receiving systems), the plant (or business) receives in Oracle 12 (Direct material along with packing slip, bill of Lading and Web-ERS document). Then, the system determines if a relevant ASN exist in Oracle/Mas-H to receive against 14. If an ASN exists, then the plant receives against the ASN 16. If an ASN does not exist, then the plant inputs manual receipt data to receive 18. The receiver from either step 16 or 18 is then fed to e-Pack 20. The process then determines if there is a discrepancy between ASN and received quantity or is ASN missing 22. If no, the receiver is release 24 and then the receiver is fed to LPC 6 to perform a 2-way match. If there is a discrepancy between ASN and received quantity or if the ASN is missing, then the system confirms that a request was sent to the supplier and the transaction was sent to an action queue 26. If the supplier agrees 28, then the receiver is released 24 and fed to LPC 6. The supplier must confirm quantity and input price (on manual receipts only) and override shipment identification. If not confirmed, then auto-release quantity discrepancy transactions (received quantity and input price within fifty (50) days (excluding international). If the supplier disagrees, then the supplier is instructed to call the plant to correct receiving 30, and thereafter the receiver is released 24 and fed to LPC 6.

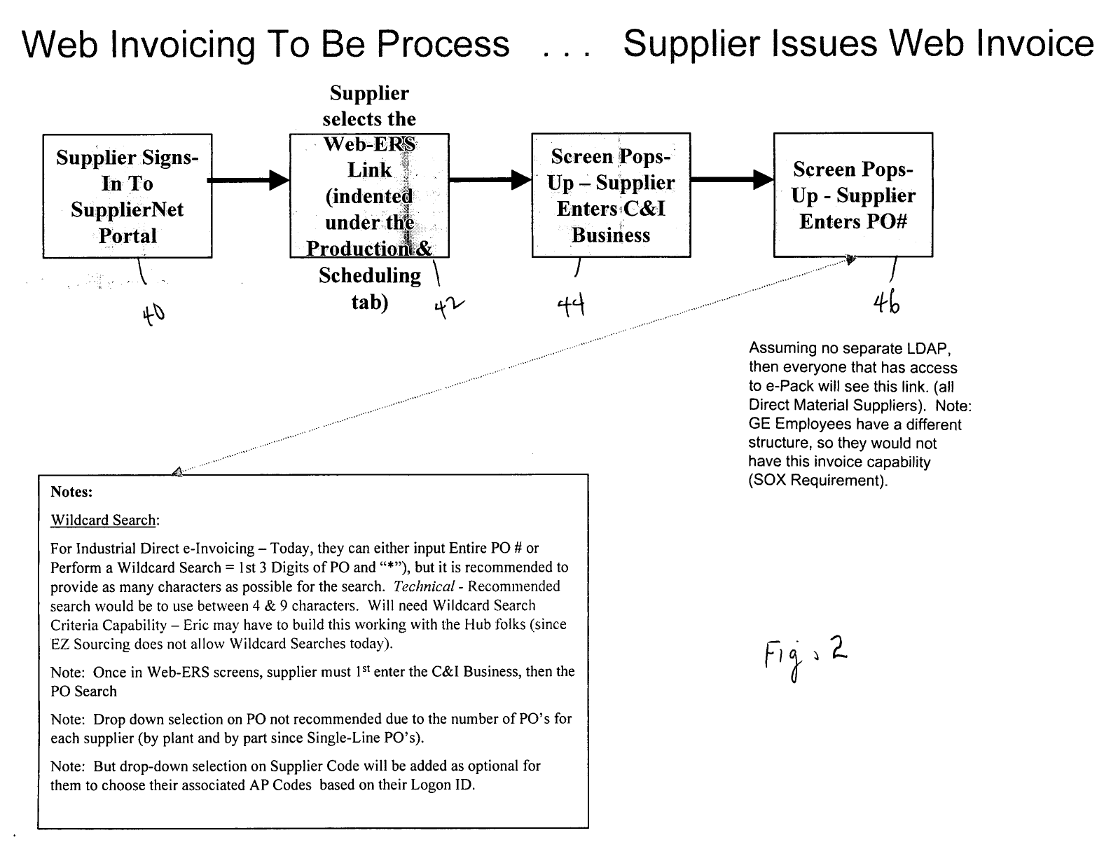

FIG. 2 depicts a process according to the present invention when a supplier issues a web invoice. That is, supplier signs-in to a supplier net portal 40. Thereafter, the supplier selects the Web ERS link (indented under the production and scheduling tab) 42. The screen pops-up and requires the supplier to enter selected business unit 44 and thereafter the screen pops-up and the supplier enters a PO number 46.

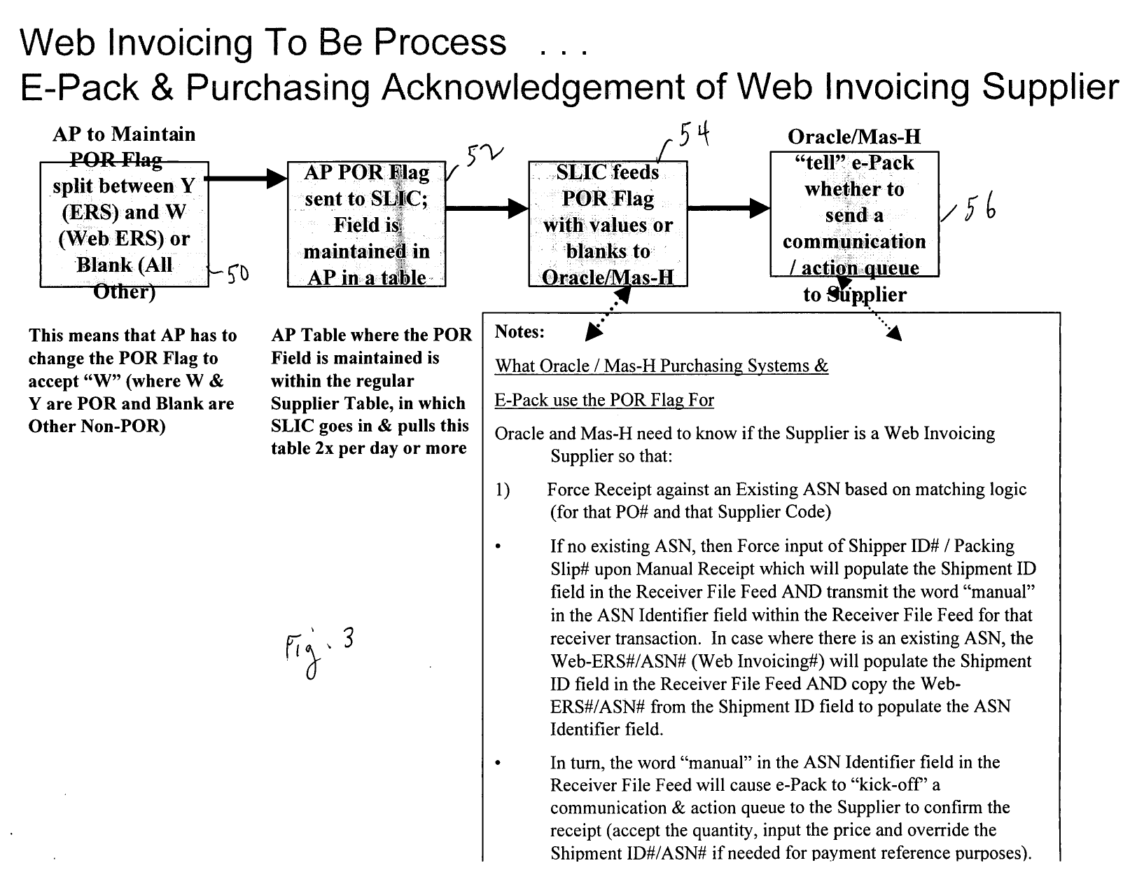

FIG. 3 depicts the e-Pack and purchasing acknowledgement of web invoicing supplier according to the present disclosure. Accounts payable maintains a PO record flag split between Y (ERS) and W (Web ERS) or blank (all others) 50. This means that account payable has to change the PO record flag to accept “W” (where W and Y are PO record and blank are other non-PO records). The accounts payable flag is then sent to SLIC (system used to maintain supplier information); where the field is maintained by accounts payable in a table 52. SLIC then feeds the PO record flag with values or blanks to Oracle/Mas-H 54. Finally, thee Oracle/Mas-H tells e-Pack whether to send a communication/action queue to the supplier 56.

The Oracle and Mas-H purchasing system needs to know if the supplier is a web invoicing supplier so that it can force receipt against an existing ASN based on matching logic (for that PO number and that supplier code). If no existing ASN, then force input of shipper identification number/packing slip number upon manual receipt which will populate the shipment identification field in the receiver file feed and transmit the word “manual” in the ASN identifier field within the receiver file feed for that receiver transaction. In cases where there is an existing ASN, the Web-ERS number/ASN number (web invoicing number) will populate the shipment identification field in the receiver file feed and copy the web-ERS number/ASN number from the shipment identification field to populate the ASN identifier field. In turn, the word “manual” in the ASN identifier field in the receiver file feed will cause e-Pack to “kick-off” a communication and action queue to the supplier to confirm the receipt (accept the quantity, input the price and override the shipment identification number/ASN number if needed for payment reference purposes.

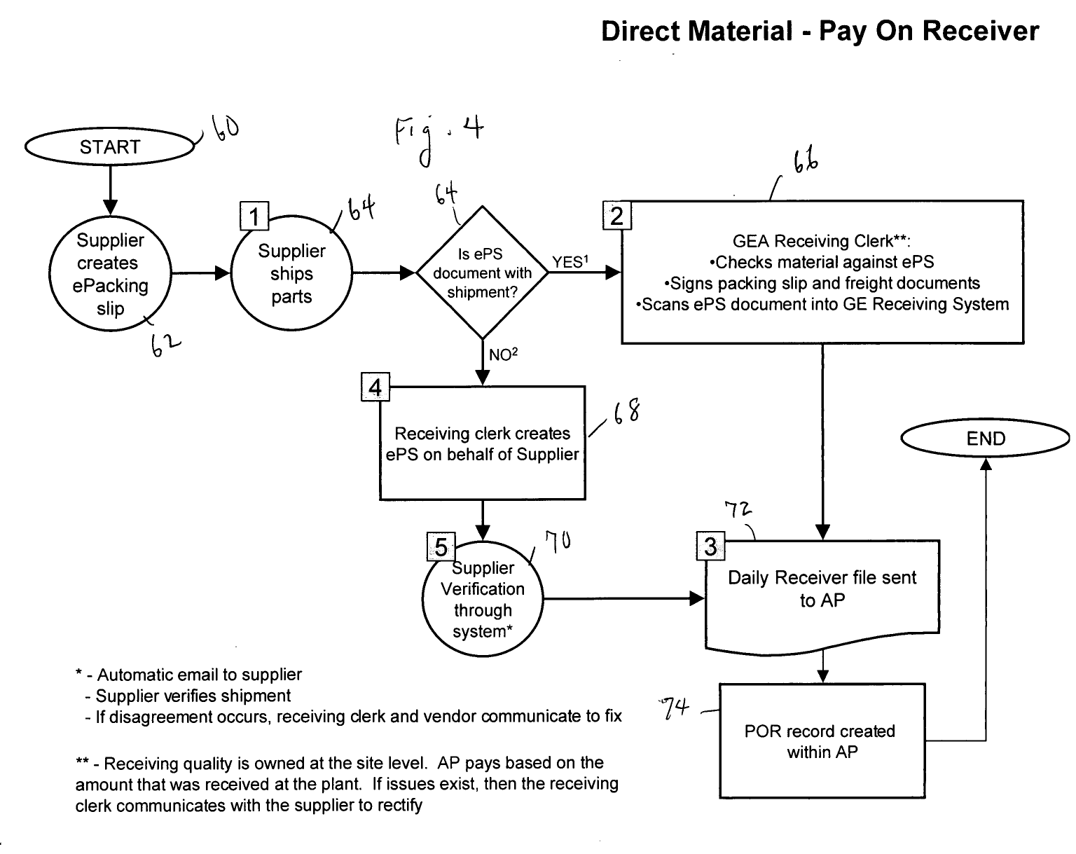

FIG. 4 is a logic diagram depicting the pay on receiver flowchart according to the present disclosure. The logic starts 60 by supplier creating an ePacking slip 62. The supplier then ships the parts 64 and the system determines how to proceed based on if the ePS document is with the shipment 64. If the ePS document is with the shipment, then GEA receiving clerk checks the material against the ePS, signs the packing slip and freight documents and scans the ePS document into the receiving system 66. If the ePS document is not with the shipment, then the receiving clerk creates the ePS document on behalf of the supplier 68. An automatic email is then sent to the supplier for verification 70. Thereafter, the daily receiver file is sent to accounts payable 72, which then creates a PO record within accounts payable 74.

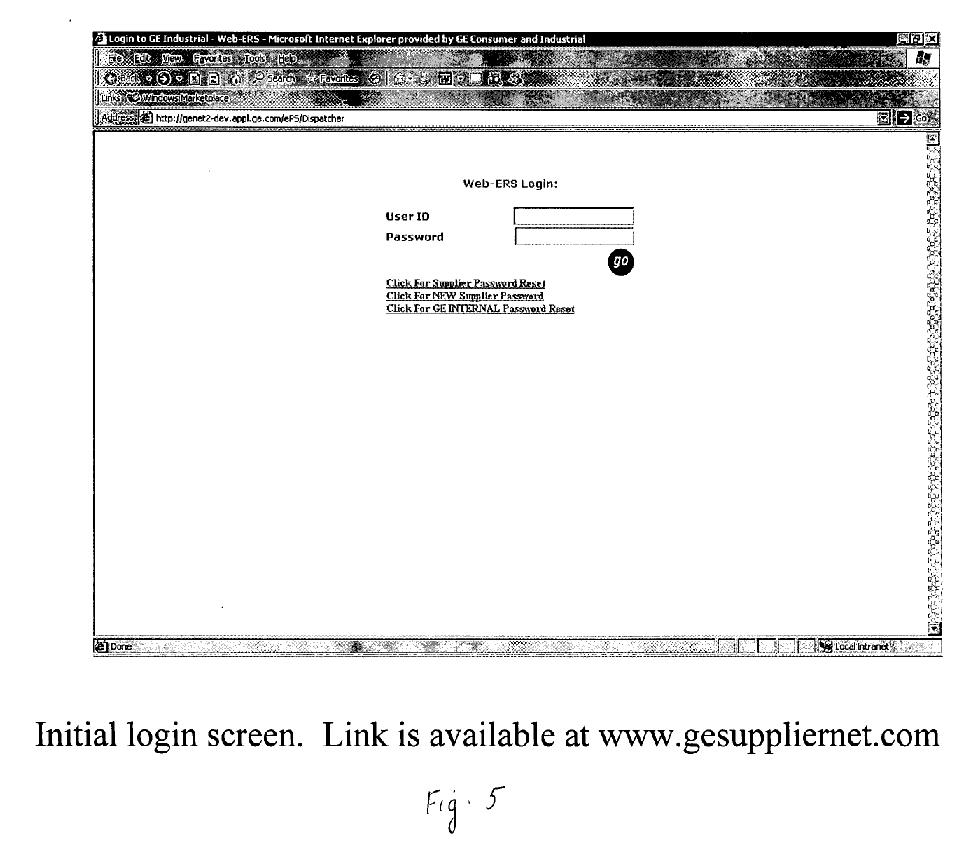

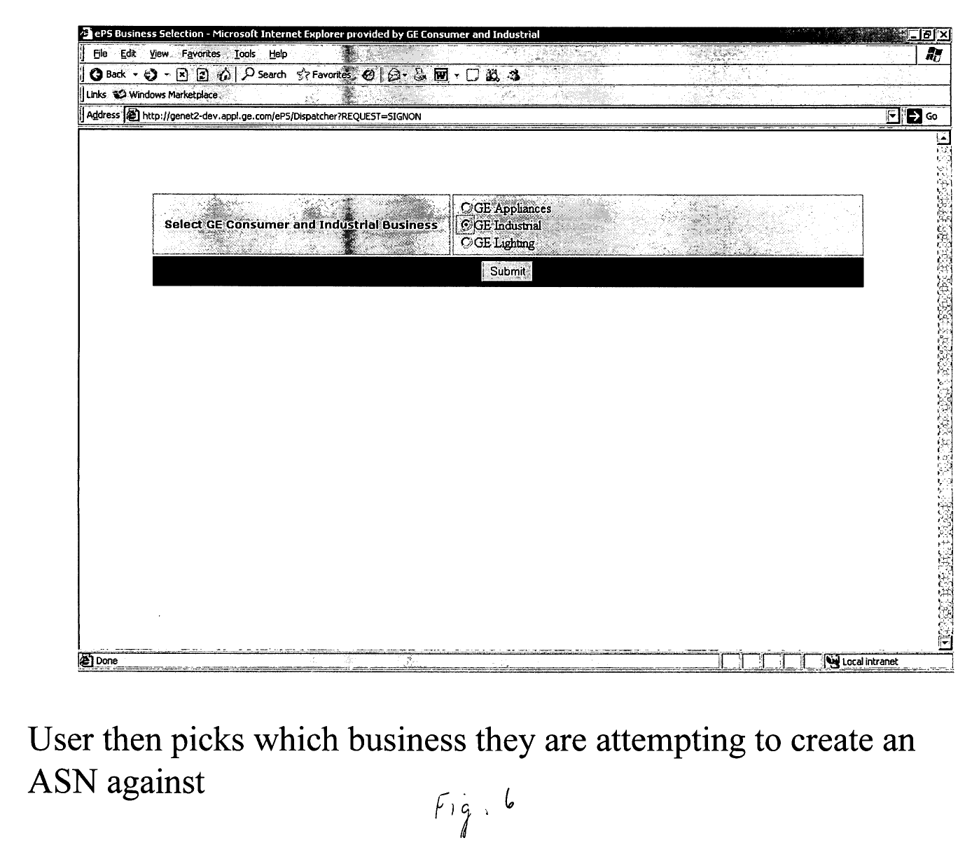

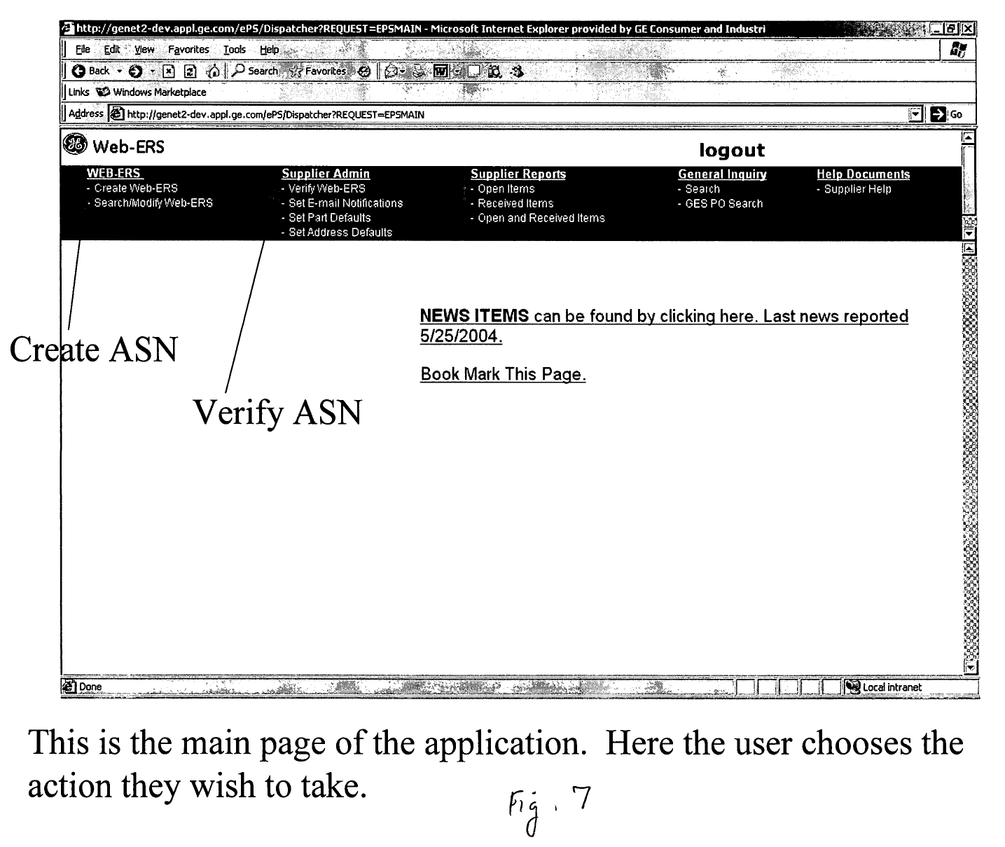

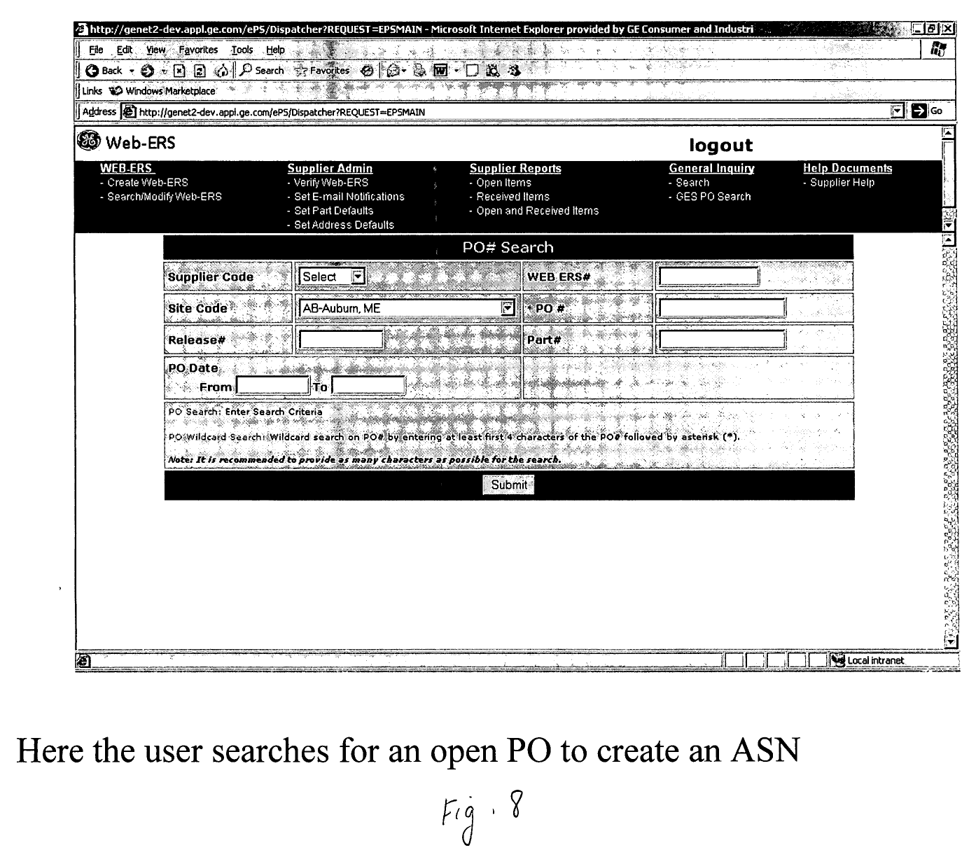

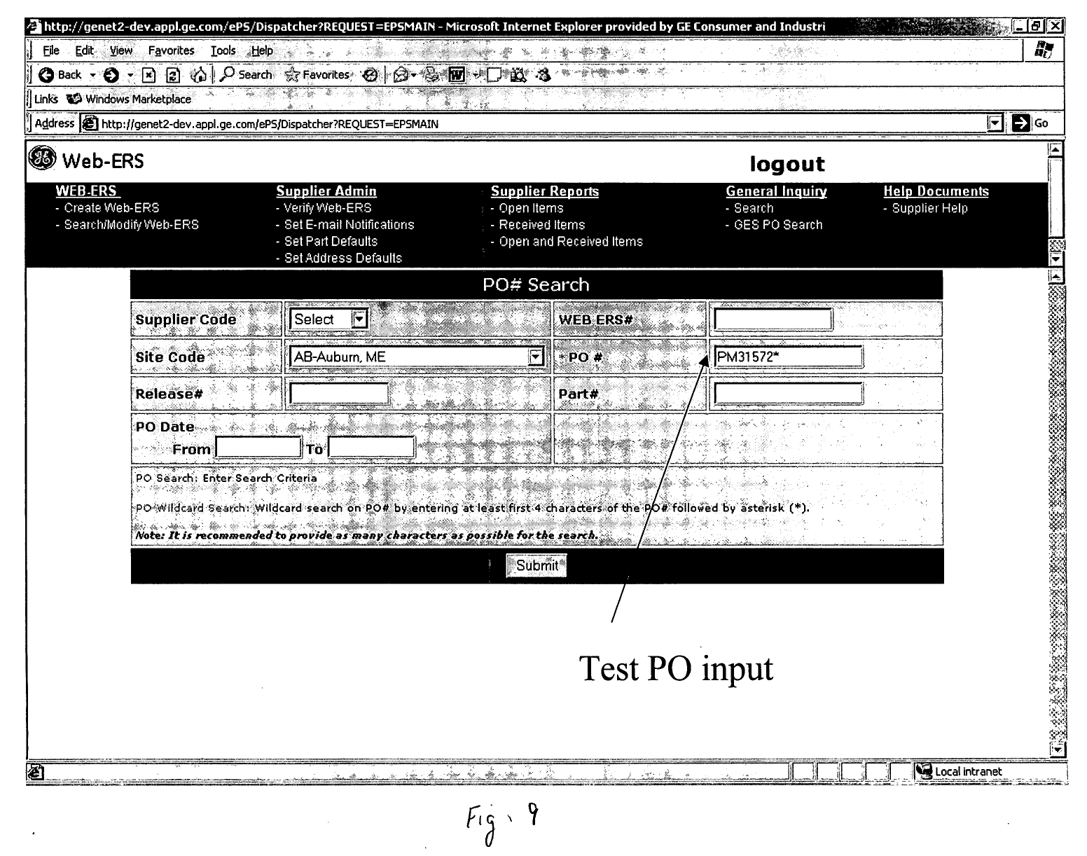

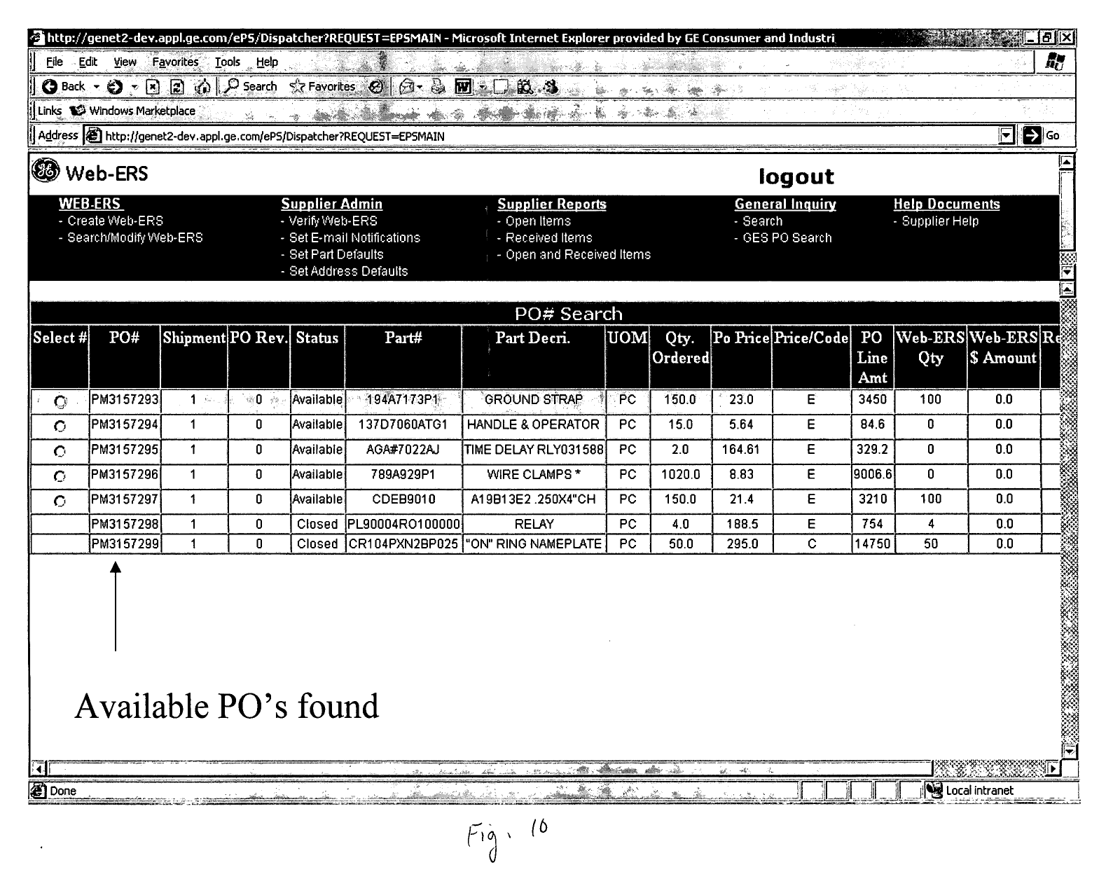

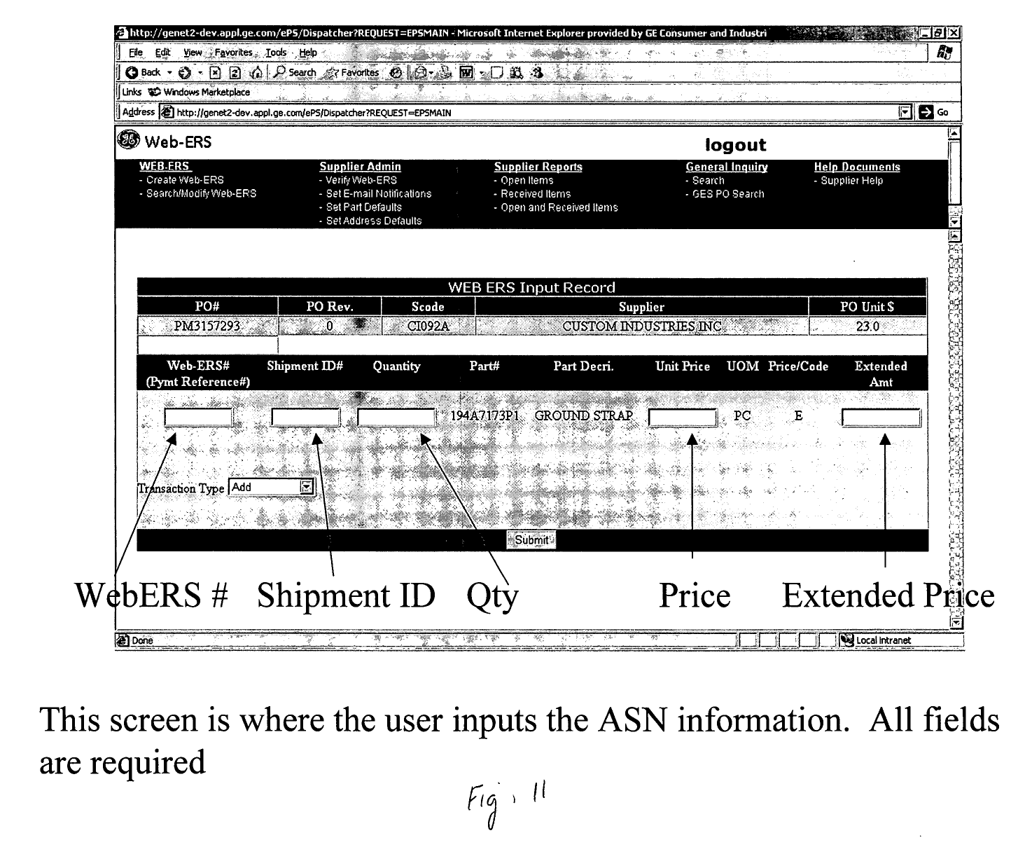

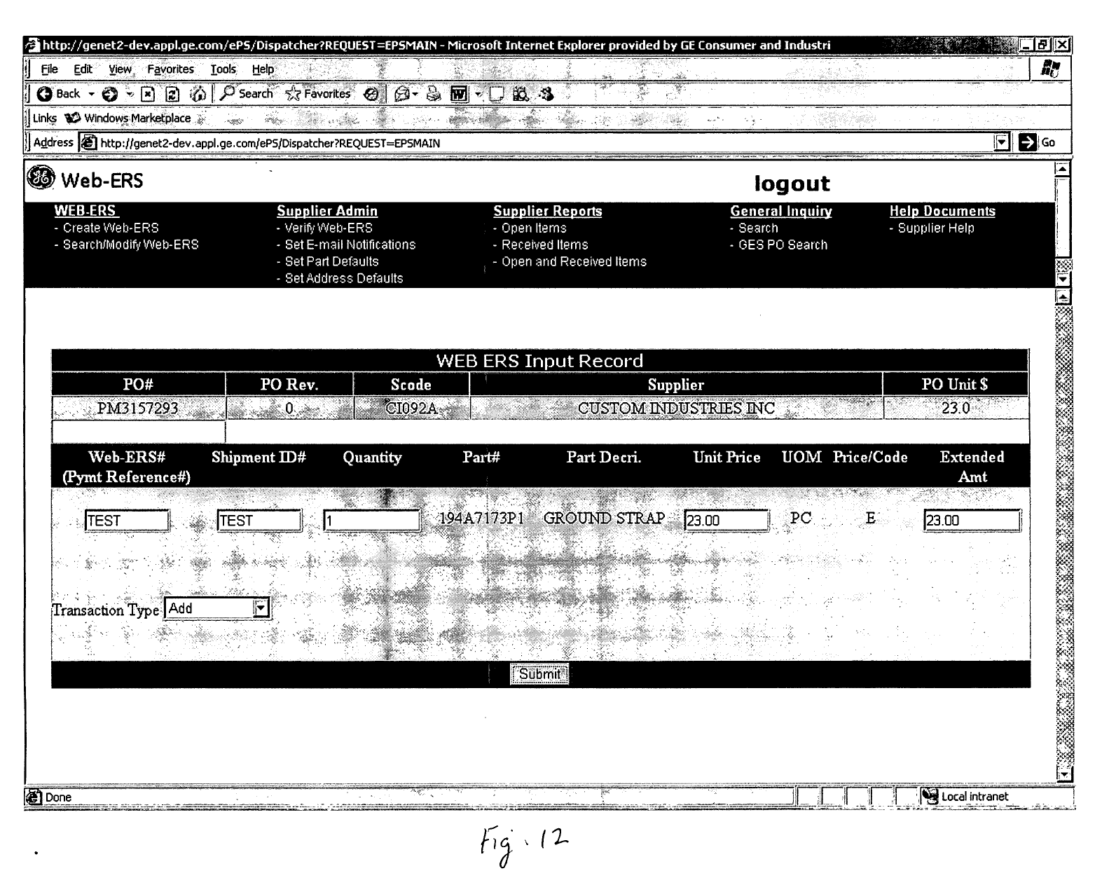

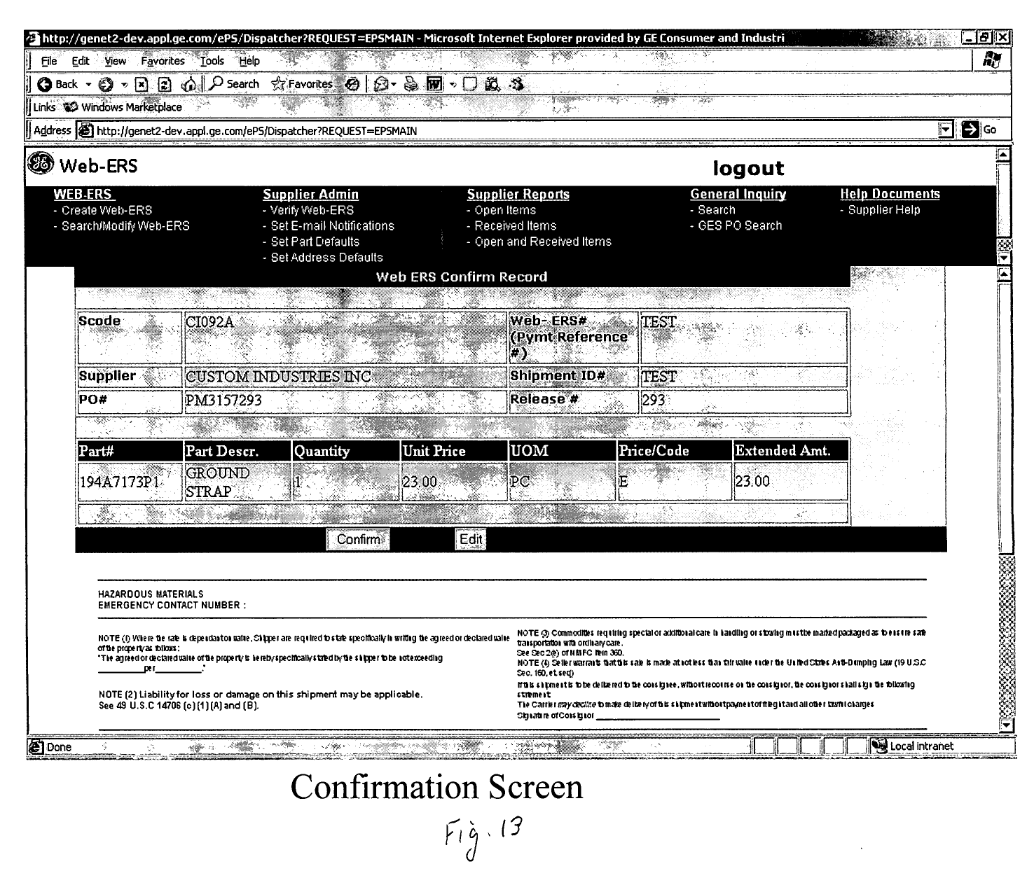

FIGS. 5-13 depict screen shots for showing how the system is utilized on a website, wherein FIG. 5 is the initial login screen, FIG. 6 requires the user to pick which business they are attempting to create an ASN against, FIG. 7 is the main page of the application where the user chooses the action they wish to take, FIG. 8 show how the user searches for an open PO to create an ASN, FIG. 9 is a test PO input, FIG. 10 show the available PO's found, FIGS. 11 & 12 is the screen where the user inputs the ASN information, and FIG. 13 is the confirmation screen.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for web-based evaluated receipt settlement of a invoice, said method comprising:
generating a purchase order number for a product;
shipping of said product to customer by supplier;
issuing of a receipt settlement via an Internet or Intranet to said customer;
determining if a shipping notice exists to receive against said receipt settlement;
generating a receiver file if a shipping notice exists;
determining if there is any discrepancy between said shipping notice and the quantity of said products set forth in said receiver file;
determining if said receiver file should be released to accounts payable; and
performing a 2-way match of said receiver file.

2. The method according to claim 1, wherein said 2-way match comprises:
comparing said shipping notice on the receipt with the shipping notice recorded by the supplier;
if the quantity, supplier and shipping notice match, sending the receiver file to accounts payable;
if the quantity does not match, sending a notice to said supplier indicating that the quantities are different and that they must verify the received quantity; and
if the supplier does not agree with the received quantity, contacting customer to resolve quantity differences.

3. The method according to claim 1, further comprising:
if there is no shipping notice to receive against, manually inserting receipt data; and
generating said receiver file.

4. The method according to claim 1, further comprising:
if there is a discrepancy between said shipping notice and the quantity of said products set forth in said receiver file, transmitting a confirmation request to said supplier;
determining if said supplier confirms said quantity and an input price; and
if said supplier confirms said quantity and said input price, releasing said receiver file to accounts payable.

5. The method according to claim 1, wherein said step of generating a purchase order number for a product comprises:
logging onto a website by said supplier;
selecting a web-based evaluated receipt settlement link;
entering a desired customer; and
entering a purchase order.

6. A method for generating an automated shipping notice for a product to be shipped, said method comprising:
logging on to an automated shipping notice website;
selecting an available purchase order for said product;
inputting automated shipping notice data;
submitting said automated shipping notice data; and
confirming that said automated shipping notice has been logged into memory.
